(19) United States
(12) Patent Application Publication
(10) Pub. No.: US 2026/0034607 A1
(43) Pub. Date: Feb. 5, 2026

(54) LASER MODULE AND LASER PROCESSING MACHINE

(71) Applicant: SEIKO EPSON CORPORATION, Tokyo (JP)

(72) Inventor: Eiji MORIKUNI, MATSUMOTO-SHI (JP)

(73) Assignee: SEIKO EPSON CORPORATION, Tokyo (JP)

(21) Appl. No.: 19/284,672

(22) Filed: Jul. 29, 2025

(30) Foreign Application Priority Data
Jul. 30, 2024 (JP) 2024-123384

(51) Int. Cl. B23K 26/06; B23K 101/40

(52) U.S. Cl. CPC B23K 26/0604; B23K 26/0643; B23K 26/0665; B23K 2101/40

(57) ABSTRACT

A laser module including first and second light sources, a second mirror transmitting a first beam reflected by a first mirror and reflecting a second beam emitted from the second light source, and a light condensing optical system, wherein the first beam is condensed at a first position in an optical path from the first light source to the first mirror, the second beam is condensed at a second position in an optical path from the second light source to the second mirror, an optical path length from the first light source to the first position is larger than an optical path length from the second light source to the second position, and an optical path length from the first light source to the light condensing optical system is larger than an optical path length from the second light source to the light condensing optical system.

The present application is based on, and claims priority from JP Application Serial Number 2024-123384, filed Jul. 30, 2024, the disclosure of which is hereby incorporated by reference herein in its entirety.

### BACKGROUND

### 1. Technical Field

The present disclosure relates to a laser module and a laser processing machine.

### 2. Related Art

A laser module is known that multiplexes beams from a plurality of semiconductor laser light sources and emits the multiplexed beams in order to achieve a high output.

For example, JP 2000-141757 A describes a light beam exposure apparatus including a plurality of light source units having different wavelength characteristics, a dichroic mirror that multiplexes light beams having different wavelength characteristics respectively emitted from the plurality of light source units, and an imaging optical system that irradiates an exposure surface with the light beams from the dichroic mirror.

However, in the light beam exposure apparatus described in JP 2000-141757 A, since the plurality of light source units are provided in a stepwise manner, it is difficult to adjust positions of the plurality of light source units.

### SUMMARY

An aspect of a laser module according to the present disclosure includes
a first substrate,
a first semiconductor laser light source provided at the first substrate and configured to emit a first beam in a first direction,
a second semiconductor laser light source provided at the first substrate and configured to emit a second beam in the first direction,
a first mirror configured to reflect the first beam emitted in the first direction from the first semiconductor laser light source,
a second mirror configured to transmit the first beam reflected by the first mirror in a second direction different from the first direction and reflect the second beam emitted from the second semiconductor laser light source in the second direction, and
a light condensing optical system configured to condense the first beam and the second beam from the second mirror, wherein
the first beam emitted from the first semiconductor laser light source is condensed at a first position in an optical path from the first semiconductor laser light source to the first mirror,
the second beam emitted from the second semiconductor laser light source is condensed at a second position in an optical path from the second semiconductor laser light source to the second mirror,
an optical path length from the first semiconductor laser light source to the first position is larger than an optical path length from the second semiconductor laser light source to the second position, and
an optical path length from the first semiconductor laser light source to the light condensing optical system is larger than an optical path length from the second semiconductor laser light source to the light condensing optical system.

An aspect of a laser processing machine according to the present disclosure includes
the laser module.

### BRIEF DESCRIPTION OF THE DRAWINGS

FIG. 1 is a diagram schematically illustrating a laser module according to the embodiment.

FIG. 2 is a diagram schematically illustrating the laser module according to the embodiment.

FIG. 3 is a cross-sectional view schematically illustrating a first semiconductor laser light source of the laser module according to the embodiment.

FIG. 4 is a diagram schematically illustrating a laser module according to a first modification of the embodiment.

FIG. 5 is a cross-sectional view schematically illustrating a first semiconductor laser light source and a position adjustment mechanism of the laser module according to the first modification of the embodiment.

FIG. 6 is a diagram schematically illustrating the first semiconductor laser light source and the position adjustment mechanism of the laser module according to the first modification of the embodiment.

FIG. 7 is a diagram schematically illustrating a laser module according to a second modification of the embodiment.

FIG. 8 is a diagram schematically illustrating the laser module according to the second modification of the embodiment.

FIG. 9 is a diagram schematically illustrating the laser module according to the second modification of the embodiment.

FIG. 10 is a perspective view schematically illustrating a laser module according to a third modification of the embodiment.

FIG. 11 is a diagram schematically illustrating the laser module according to the fourth modification of the embodiment.

FIG. 12 is a diagram schematically illustrating the laser module according to the fourth modification of the embodiment.

FIG. 13 is a diagram schematically illustrating the laser module according to the fifth modification of the embodiment.

FIG. 14 is a diagram schematically illustrating the laser module according to the fifth modification of the embodiment.

FIG. 15 is a diagram schematically illustrating a laser processing machine according to the embodiment.

### DESCRIPTION OF EMBODIMENTS

A preferred embodiment of the present disclosure is described in detail below with reference to the drawings. The embodiment to be described below does not unduly limit the content of the present disclosure described in the claims. In addition, not all the configurations described below are essential constituent elements of the present disclosure.

### 1. Laser Module

### 1.1. Overall Configuration

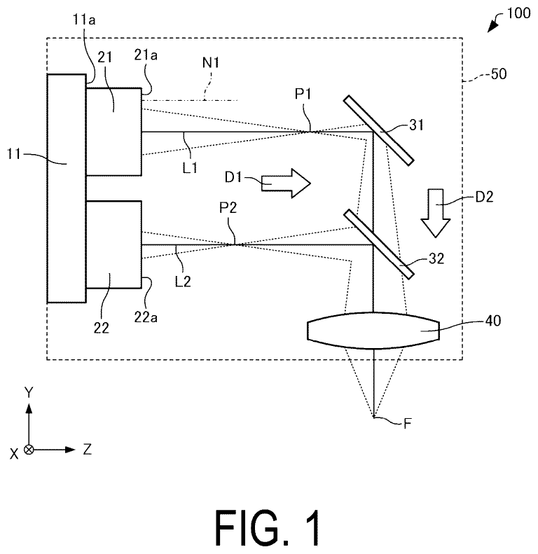

First, a laser module according to the embodiment will be described with reference to the drawings. FIG. 1 is a diagram schematically illustrating a laser module 100 according to the embodiment. Note that, an X-axis, a Y-axis, and a Z-axis are illustrated in FIG. 1 as three axes orthogonal to each other.

As illustrated in FIG. 1, the laser module 100 includes, for example, a first substrate 11, a first semiconductor laser light source 21, a second semiconductor laser light source 22, a first mirror 31, a second mirror 32, a light condensing optical system 40, and a housing 50. Note that for the sake of convenience, in FIG. 1, illustration is given through the housing 50.

The first substrate 11 supports the first semiconductor laser light source 21 and the second semiconductor laser light source 22. The first substrate 11 includes a first plane 11a. The first plane 11a is a flat surface. The first substrate 11 is, for example, a copper substrate, a silicon substrate, or the like. The first substrate 11 dissipates heat generated in the semiconductor laser light sources 21 and 22.

The first semiconductor laser light source 21 is provided at the first plane 11a of the first substrate 11. The first semiconductor laser light source 21 is directly provided at the first plane 11a, for example. The first semiconductor laser light source 21 includes an emission surface 21a that emits light. In the illustrated example, the emission surface 21a is parallel to the plane 11a. A perpendicular line N1 of the emission surface 21a is parallel to the Z-axis. The emission surface 21a is a surface of the first semiconductor laser light sources 21 on an opposite side to the first substrate 11.

The first semiconductor laser light source 21 emits a first beam L1 in a first direction D1. The first direction D1 is a direction along the perpendicular line N1. In the illustrated example, the first direction D1 is a +Z-axis direction. Here, “emitting light in an A direction” means emitting light such that an optical axis of the light is in the A direction. Similarly, “transmitting light in the A direction” and “reflecting light in the A direction” mean transmitting and reflecting the light such that an optical axis of the light is in the A direction, respectively. “An optical axis of light” refers to a light beam passing through a center of the light condensing optical system 40 in a light flux.

The first beam L1 emitted from the first semiconductor laser light source 21 is condensed at a first position P1 in an optical path from the first semiconductor laser light source 21 to the first mirror 31. In the illustrated example, the first beam L1 is condensed at the first position P1 between the first semiconductor laser light sources 21 and the first mirror 31. The first beam L1 condensed at the first position P1 diverges and enters the first mirror 31.

The second semiconductor laser light source 22 is provided at the first plane 11a of the first substrate 11. The second semiconductor laser light source 22 is directly provided at the first plane 11a, for example. In the illustrated example, the semiconductor laser light sources 21 and 22 are arranged in the Y-axis direction. The emission surface 21a of the first semiconductor laser light source 21 and an emission surface 22a of the second semiconductor laser light source 22 are located at the same plane.

The second semiconductor laser light source 22 emits a second beam L2 in the first direction D1. The second beam L2 is condensed at a second position P2 in an optical path from the second semiconductor laser light source 22 to the second mirror 32. In the illustrated example, the second beam L2 is condensed at the second position P2 between the second semiconductor laser light source 22 and the second mirror 32. The second beam L2 condensed at the second position P2 diverges and enters the second mirror 32.

An optical path length from the first semiconductor laser light source 21 to the first position P1 is larger than an optical path length from the second semiconductor laser light source 22 to the second position P2. In the illustrated example, a distance between the first semiconductor laser light source 21 and the first position P1 is larger than a distance between the second semiconductor laser light source 22 and the second position P2. Each of the semiconductor laser light sources 21 and 22 is, for example, a photonic crystal surface emitting laser (PCSEL). In the semiconductor laser light sources 21 and 22, by adjusting an arrangement of photonic crystals or the like, the first position P1 and the second position P2, which are condensing positions, can be adjusted by composite modulation.

A radiation angle of the first beam L1 emitted from the first semiconductor laser light source 21 and a radiation angle of the second beam L2 emitted from the second semiconductor laser light source 22 are, for example, the same as each other.

The first mirror 31 reflects the first beam L1 emitted in the first direction D1 from the first semiconductor laser light source 21, in the second direction D2. The second direction D2 is a direction different from the first direction D1. The first direction D1 and the second direction D2 are directions orthogonal to each other. In the illustrated example, the second direction D2 is a −Y-axis direction. The first mirror 31 bends the first beam L1 by 90°.

The second mirror 32 transmits the first beam L1 reflected by the first mirror 31 in the second direction D2, and reflects the second beam L2 emitted in the first direction D1 from the second semiconductor laser light source 22 in the second direction D2. Then, the second mirror 32 multiplexes the first beam L1 and the second beam L2 and guides the multiplexed beams to the light condensing optical system 40. The second mirror 32 bends the second beam L2 by 90°. An optical path length from the first semiconductor laser light source 21 to the second mirror 32 is larger than an optical path length from the second semiconductor laser light source 22 to the second mirror 32. An optical path length from the first position P1 to the second mirror 32 and an optical path length from the second position P2 to the second mirror 32 are, for example, the same as each other.

The second mirror 32 is, for example, a polarization beam combiner (PBC). For example, the semiconductor laser light sources 21 and 22, which are PCSELs, can adjust polarization directions of the beams L1 and L2, respectively, by composite modulation. The polarization directions of the beams L1 and L2 are different from each other. For example, the first beam L1 is P-polarized light, and the second beam L2 is S-polarized light. In the illustrated example, the mirrors 31 and 32 are arranged in the Y-axis direction. The beams L1 and L2 enter the second mirror 32 as beams having polarization directions different from each other. The beams L1 and L2 have the same polarization direction when emitted from the semiconductor laser light sources 21 and 22, respectively, but may have polarization directions different from each other when entering the second mirror 32.

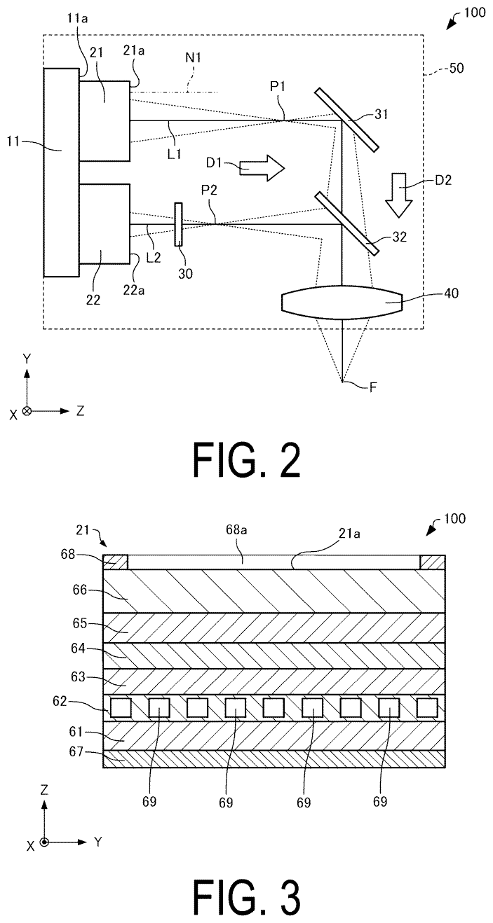

Note that the polarization directions of the first beam L1 emitted from the first semiconductor laser light source 21 and the second beam L2 emitted from the second semiconductor laser light source 22 may be the same as each other. The beams L1 and L2 may be, for example, P-polarized light. In this case, as illustrated in FIG. 2, a λ/2 plate 30 is provided in the optical path from the second semiconductor laser light source 22 to the second mirror 32. The λ/2 plate 30 converts the P-polarized second beam L2 emitted from the second semiconductor laser light source 22 into S-polarized light. Accordingly, the second mirror 32 can multiplex the first beam L1 emitted from the first semiconductor laser light source 21 and the second beam L2 emitted from the second semiconductor laser light source 22. In the illustrated example, the λ/2 plate 30 is provided between the second semiconductor laser light sources 22 and the second position P2.

However, as long as the semiconductor laser light sources 21 and 22 are PCSELs, the polarization of the beams L1 and L2 can be adjusted by composite modulation without using the λ/2 plate 30, and thus the number of components can be reduced, and a size and costs can be reduced.

The first beam L1 and the second beam L2 from the second mirror 32 enter the light condensing optical system 40, as illustrated in FIG. 1. To be specific, the first beam L1 passing through the second mirror 32 and the second beam L2 reflected by the second mirror 32 enter the light condensing optical system 40. An optical path length from the first semiconductor laser light source 21 to the light condensing optical system 40 is larger than an optical path length from the second semiconductor laser light source 22 to the light condensing optical system 40. An optical path length from the first position P1 to the light condensing optical system 40 and an optical path length from the second position P2 to the light condensing optical system 40 are, for example, the same as each other.

The light condensing optical system 40 condenses the beams L1 and L2 from the second mirror 32. In the laser module 100, the beams L1 and L2 can be condensed at a light condensing point F of the light condensing optical system 40 so that light condensing positions and the light condensing angles are made uniform. The light condensing point F is an imaging point of the light condensing optical system 40. Magnifications of a light-source image formed by the first beam L1 and a light-source image formed by the second beam L2 are the same at the light condensing point F. The light condensing optical system 40 is a condensing lens. In the illustrated example, the light condensing optical system 40 is a convex lens.

The housing 50 accommodates the first substrate 11, the semiconductor laser light sources 21, 22, the mirrors 31, 32, and the light condensing optical system 40. A shape and a material of the housing 50 are not particularly limited. Although not illustrated, the housing 50 includes a window portion that transmits the beams L1 and L2 passing through the light condensing optical system 40. The housing 50 can facilitate handling of the laser module 100.

### 1.2. Configuration of Semiconductor Laser Light Source

FIG. 3 is a cross-sectional view schematically illustrating the first semiconductor laser light source 21. As illustrated in FIG. 3, the first semiconductor laser light source 21 includes, for example, a first semiconductor layer 61, a first guide layer 62, a quantum well layer 63, a second guide layer 64, a second semiconductor layer 65, a transparent substrate 66, a first electrode 67, and a second electrode 68. The first semiconductor laser light source 21 and the second semiconductor laser light source 22 basically have structures the same as each other. Therefore, the following description of the first semiconductor laser light source 21 can be applied to the description of the second semiconductor laser light source 22.

The first semiconductor layer 61 is provided between the first electrode 67 and the first guide layer 62. The first semiconductor layer 61 is a semiconductor layer of a first conductivity type. The first semiconductor layer 61 is, for example, a p-type semiconductor layer doped with Mg.

The first guide layer 62 is provided between the first semiconductor layer 61 and the quantum well layer 63. The first guide layer 62 has, for example, a semiconductor superlattice (SL) structure composed of a GaN layer and an InGaN layer, which are an i-type and not intentionally doped with impurities. The numbers of the GaN layers and the InGaN layers composing the first guide layer 62 are not particularly limited.

An opening portion 69 is formed at the first guide layer 62. The opening portion 69 is, for example, a hole. A width of the opening portion 69 is, for example, from 50 nm to 500 nm. A plurality of the opening portions 69 are formed. The plurality of opening portions 69 are periodically arrayed when viewed from the Z-axis direction. The plurality of opening portions 69 are arrayed in, for example, a regular triangular lattice pattern or a square lattice pattern. The plurality of opening portions 69 can exhibit a photonic crystal effect.

The quantum well layer 63 is provided between the first guide layer 62 and the second guide layer 64. The quantum well layer 63 generates light when a current is injected thereinto. The quantum well layer 63 includes, for example, a well layer and a barrier layer. The well layer and the barrier layer are i-type semiconductor layers which are not doped with impurities intentionally. The well layer is, for example, an InGaN layer. The barrier layer is, for example, a GaN layer. The quantum well layer 63 has a multiple quantum well (MQW) structure composed of the well layer and the barrier layer.

Note that the numbers of the well layers and the barrier layers composing the quantum well layer 63 are not particularly limited. For example, only one well layer may be provided, and in this case, the quantum well layer 63 has a single quantum well (SQW) structure.

The second guide layer 64 is provided between the quantum well layer 63 and the second semiconductor layer 65. The second guide layer 64 has, for example, an SL structure composed of a GaN layer and an InGaN layer which are the i-type and not intentionally doped with impurities. The numbers of the GaN layers and the InGaN layers composing the second guide layer 64 are not particularly limited. The T first guide layer 62 and the second guide layer 64 have a function of increasing an optical confinement coefficient of the first semiconductor laser light source 21. Note that although not illustrated, the plurality of opening portions 69 need not be provided at the first guide layer 62 and may be provided at the second guide layer 64.

The second semiconductor layer 65 is provided between the quantum well layer 63 and the transparent substrate 66. The second semiconductor layer 65 is a semiconductor layer of a second conductivity type different from the first conductivity type. The second semiconductor layer 65 is, for example, an n-type GaN layer doped with Si. The first semiconductor layer 61 and the second semiconductor layer 65 are clad layers having a function of confining light in the quantum well layer 63.

In the first semiconductor laser light source 21, a pin diode is constituted by the first semiconductor layer 61 of the p-type, the quantum well layer 63 and the guide layers 62 and 64 which are the i-type and not intentionally doped with impurities, and the second semiconductor layer 65 of the n-type. In the first semiconductor laser light source 21, when a forward bias voltage of the pin diode is applied between the first electrode 67 and the second electrode 68, a current is injected into the quantum well layer 63, and electrons and positive holes are recombined in the quantum well layer 63. This recombination causes light emission. The light generated in the quantum well layer 63 propagates in an in-plane direction, forms a standing wave by the photonic crystal effect due to the plurality of opening portions 69, receives a gain in the quantum well layer 63, and performs laser oscillation. Then, the first semiconductor laser light source 21 emits diffracted light as laser light.

The transparent substrate 66 is provided between the second semiconductor layer 65 and the second electrode 68. The transparent substrate 66 transmits light generated in the quantum well layer 63. The transparent substrate 66 is, for example, an n-type semiconductor substrate in which Si is doped.

The first electrode 67 is provided at the first semiconductor layer 61 on an opposite side to the first guide layer 62. The first semiconductor layer 61 may be in ohmic contact with the first electrode 67. The first electrode 67 is electrically coupled to the first semiconductor layer 61. The first electrode 67 is formed by, for example, stacking a Ni layer and an Au layer in this order from the first semiconductor layer 61 side. The first electrode 67 is an electrode on one side for injecting a current into the quantum well layer 63.

The second electrode 68 is provided at the transparent substrate 66 on an opposite side to the second semiconductor layer 65. The transparent substrate 66 may be in ohmic contact with the second electrode 68. The second electrode 68 is electrically coupled to the second semiconductor layer 65 via the transparent substrate 66. The second electrode 68 is formed by, for example, stacking a Cr layer, a Ni layer, and an Au layer in this order from the transparent substrate 66 side. The second electrode 68 is an electrode on another side for injecting a current into the quantum well layer 63.

A through hole 68a is formed at the second electrode 68. Light generated in the quantum well layer 63 is emitted through the through hole 68a. A region of the transparent substrate 66 exposed by the through hole 68a constitutes the emission surface 21a.

As a manufacturing method of the first semiconductor laser light source 21, the semiconductor layers 61, 65, the guide layer 62, 64, and the quantum well layer 63 are formed by epitaxial growth such as a metal organic chemical vapor deposition (MOCVD) method and a molecular beam epitaxy (MBE) method, for example. For example, the opening portion 69 is formed by patterning the first guide layer 62 using an electron beam drawing device. The electrodes 67 and 68 are formed by a sputtering method, a vacuum deposition method, a chemical vapor deposition (CVD) method, or the like. The formed first semiconductor laser light source 21 is mounted in a junction-down manner with the first electrode 67 side facing the first substrate 11 illustrated in FIG. 1, for example.

### 1.3. Effects

The laser module 100 includes the first substrate 11, the first semiconductor laser light source 21 provided at the first substrate 11 and configured to emit the first beam L1 in the first direction D1, the second semiconductor laser light source 22 provided at the first substrate 11 and configured to emit the second beam L2 in the first direction D1, the first mirror 31 configured to reflect the first beam L1 emitted in the first direction D1 from the first semiconductor laser light source 21, the second mirror 32 configured to transmit the first beam L1 reflected by the first mirror 31 in the second direction D2 different from the first direction D1 and reflect the second beam L2 emitted from the second semiconductor laser light source 22 in the second direction D2, and the light condensing optical system 40 configured to condense the first beam L1 and the second beam L2 from the second mirror 32. The first beam L1 emitted from the first semiconductor laser light source 21 is condensed at the first position P1 in the optical path from the first semiconductor laser light source 21 to the first mirror 31, and the second beam L2 emitted from the second semiconductor laser light source 22 is condensed at the second position P2 in the optical path from the second semiconductor laser light source 22 to the second mirror 32. The optical path length from the first semiconductor laser light source 21 to the first position P1 is larger than the optical path length from the second semiconductor laser light source 22 to the second position P2. The optical path length from the first semiconductor laser light source 21 to the light condensing optical system 40 is larger than the optical path length from the second semiconductor laser light source 22 to the light condensing optical system 40.

Thus, in the laser module 100, positions of the first semiconductor laser light source 21 and the second semiconductor laser light source 22 can be adjusted by adjusting a position of the first substrate 11. Therefore, the positions of the semiconductor laser light sources 21 and 22 can be easily adjusted. Further, the semiconductor laser light sources 21 and 22 are easily mounted. Furthermore, since heat generated in the semiconductor laser light sources 21 and 22 can be dissipated by a single first substrate 11, temperature characteristics of the semiconductor laser light sources 21 and 22 can be made uniform. Thus, reliability and stability can be improved.

Further, in the laser module 100, the optical path length from the first semiconductor laser light source 21 to the first position P1 is larger than the optical path length from the second semiconductor laser light source 22 to the second position P2, and the optical path length from the first semiconductor laser light source 21 to the light condensing optical system 40 is larger than the optical path length from the second semiconductor laser light source 22 to the light condensing optical system 40, so that the light condensing positions and the condensing angles of the beams L1 and L2 can be made uniform at the light condensing point F. Accordingly, it is possible to provide the laser module 100 having a high output and a high beam parameter product (BPP).

In the laser module 100, the first beam L1 and the second beam L2 enter the second mirror 32 as beams having polarization directions different from each other, and the second mirror 32 is a polarization beam combiner. Therefore, in the laser module 100, the first beam L1 and the second beam L2 can be multiplexed at the second mirror 32.

In the laser module 100, the first semiconductor laser light source 21 and the second semiconductor laser light source 22 are provided at the first plane 11a of the first substrate 11. Therefore, in the laser module 100, the temperature characteristics of the semiconductor laser light sources 21 and 22 can be made more uniform. Therefore, temperature control for the semiconductor laser light sources 21 and 22 can be easily performed.

In the laser module 100, the first semiconductor laser light source 21 and the second semiconductor laser light source 22 are photonic crystal surface emitting lasers. Therefore, in the laser module 100, the first position P1 and the second position P2 can be adjusted by composite modulation.

### 2. Modifications of Laser Module

### 2.1. First Modification

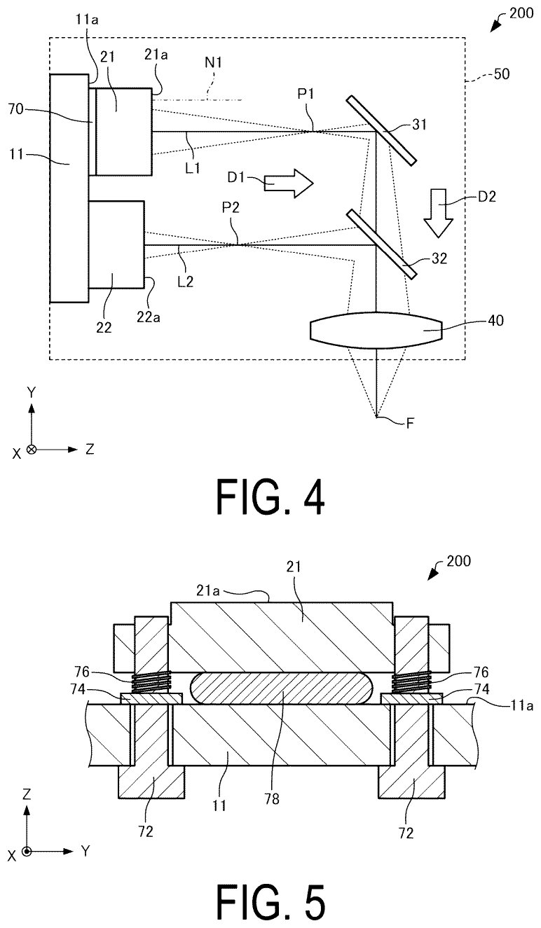

Next, a laser module according to a first modification of the embodiment will be described with reference to the drawings. FIG. 4 is a diagram schematically illustrating a laser module 200 according to the first modification of the embodiment.

In the following description, in the laser module 200 according to the first modification of the embodiment, the components with the same functions as those of the above-described laser module 100 according to the embodiment are denoted with the same reference numerals, and the description thereof is omitted.

In the laser module 100 described above, the second mirror 32 is a polarization beam combiner.

In contrast, in the laser module 200, the second mirror 32 is a dichroic mirror.

In the laser module 200, the first beam L1 emitted from the first semiconductor laser light source 21 and the second beam L2 emitted from the second semiconductor laser light source 22 have wavelengths different from each other. Thus, the second mirror 32, which is a dichroic mirror, can transmit the first beam L1 and reflect the second beam L2. For example, the semiconductor laser light sources 21 and 22, which are PCSELS, can adjust the wavelengths of the beams L1 and L2 by complex modulation. By using a PCSEL, a wavelength of emitted light can be finely set. The second mirror 32 transmits light having a predetermined wavelength or less and reflects light having a wavelength longer than the predetermined wavelength, for example.

In the laser module 200, as illustrated in FIG. 4, positions of the emission surfaces of the semiconductor laser light sources 21 and 22 in the first direction D1 are different from each other. Thus, even when the wavelengths of the beams L1 and L2 are different, light condensing positions and light condensing angles can be made uniform at the light condensing point F. In the illustrated example, the emission surface 21a of the first semiconductor laser light source 21 is located farther on the +Z-axis direction side than the emission surface 22a of the second semiconductor laser light source 22.

The laser module 200 includes a position adjustment mechanism 70 for adjusting a position of the first semiconductor laser light source 21 in the Z-axis direction. The position adjustment mechanism 70 can correct color aberration of the light condensing optical system 40.

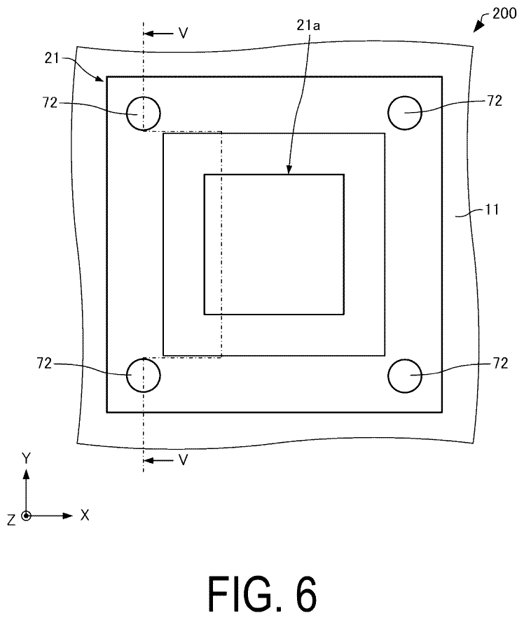

Here, FIG. 5 is a cross-sectional view schematically illustrating the first semiconductor laser light source 21 and the position adjustment mechanism 70 of the laser module 200 according to the first modification of the embodiment. FIG. 6 is a diagram schematically illustrating the first semiconductor laser light source 21 and the position adjustment mechanism 70 of the laser module 200 according to the first modification of the embodiment, as viewed from the Z-axis direction. Note that FIG. 5 is a cross-sectional view taken along line V-V in FIG. 6. Further, for the sake of convenience, FIG. 4 illustrates the position adjustment mechanism 70 in a simplified manner.

As illustrated in FIGS. 5 and 6, the first semiconductor laser light source 21 is provided at the first substrate 11 via the position adjustment mechanism 70. The position adjustment mechanism 70 includes, for example, an adjustment screw 72, a washer 74, and a spring 76.

The adjustment screw 72 penetrates the first substrate 11 and the first semiconductor laser light source 21. In the example illustrated in FIG. 6, the adjustment screws 72 are provided at four corners of the first semiconductor laser light source 21 as viewed from the Z-axis direction. In the example illustrated in FIG. 5, a head of the adjustment screw 72 is provided at the first substrate 11 on an opposite side to the first semiconductor laser light source 21. The adjustment screw 72 is rotatable about an axis parallel to the Z-axis as a rotation axis.

The washer 74 and the spring 76 are provided at the adjustment screw 72. The first semiconductor laser light source 21 is biased in a direction away from the first substrate 11 by the washer 74 and the spring 76. Accordingly, the first semiconductor laser light source 21 can be displaced in the Z-axis direction with respect to the first substrate 11 by rotating the adjustment screw 72.

A heat conductive paste 78 is provided between the first semiconductor laser light source 21 and the first substrate 11. The heat conductive paste 78 is in contact with the first semiconductor laser light source 21 and the first substrate 11. The heat conductive paste 78 has fluidity and shrinkability. Therefore, even when a distance between the first semiconductor laser light source 21 and the first substrate 11 changes, the heat conductive paste 78 can be in contact with the first semiconductor laser light source 21 and the first substrate 11. This allows heat generated in the first semiconductor laser light source 21 to be efficiently transferred to the first substrate 11.

As a method of correcting the color aberration of the light condensing optical system 40, for example, a method can be cited in which a power meter is provided at an imaging point of the condensing optical system 40, the adjustment screw 72 is rotated while the first semiconductor laser light source 21 is driven to displace the position of the first semiconductor laser light source 21 in the Z-axis direction, and adjustment is performed so that a value of the power meter becomes maximum.

In the laser module 200, the first beam L1 and the second beam L2 have the wavelengths different from each other, and the second mirror 32 is a dichroic mirror. Therefore, in the laser module 200, the first beam L1 and the second beam L2 can be multiplexed at the second mirror 32.

In the laser module 200, the positions of the emission surfaces in the first direction D1 are different from each other in the first semiconductor laser light source 21 and the second semiconductor laser light source 22. Therefore, in the laser module 200, the color aberration of the light condensing optical system 40 can be corrected.

Note that although not illustrated, the emission surface 21a of the first semiconductor laser light source 21 may be located farther on a −Z-axis direction side of the emission surface 22a than the second semiconductor laser light source 22. Further, the laser module 200 may include the position adjustment mechanism 70 for adjusting a position of the second semiconductor laser light source 22 in the Z-axis direction.

Further, the position adjustment mechanism 70 need not be provided, and an achromatic lens with corrected color aberration may be used as the light condensing optical system 40 to make the light condensing positions and the light condensing angles of the beams L1 and L2 uniform at the light condensing point F. This makes it possible to equalize an optical path length from the first semiconductor laser light source 21 to the second mirror 32 and an optical path length from the first semiconductor laser light source 21 to the second mirror 32.

### 2.2. Second Modification

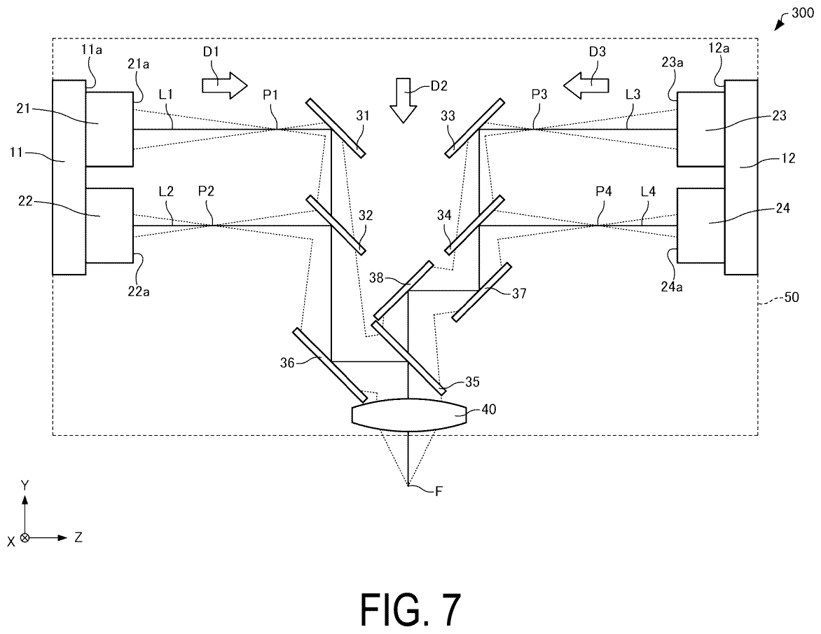

Next, a laser module according to a second modification of the embodiment will be described with reference to the drawings. FIG. 7 is a diagram schematically illustrating a laser module 300 according to the second modification of the embodiment.

In the following description, in the laser module 300 according to the second modification of the embodiment, the components with the same functions as those of the above-described laser module 100 according to the embodiment are denoted with the same reference numerals, and the description thereof is omitted.

As illustrated in FIG. 7, the laser module 300 is different from the laser module 100 described above in that a second substrate 12, a third semiconductor laser light source 23, a fourth semiconductor laser light source 24, a third mirror 33, a fourth mirror 34, a fifth mirror 35, mirrors 36, 37, and 38 are included. The second substrate 12, the semiconductor laser light sources 23, 24, the mirrors 33, 34, 35, 36, 37, and 38 are accommodated in the housing 50.

The second substrate 12 is provided facing the first substrate 11. The second substrate 12 supports the third semiconductor laser light source 23 and the fourth semiconductor laser light source 24. The second substrate 12 includes a second plane 12a. The second plane 12a of the second substrate 12 faces the first plane 11a of the first substrate 11. The second plane 12a is a flat surface. A material of the second substrate 12 is the same as a material of the first substrate 11, for example. The second substrate 12 dissipates heat generated in the semiconductor laser light sources 23 and 24.

The third semiconductor laser light source 23 is provided at the second plane 12a of the second substrate 12. The third semiconductor laser light source 23 is directly provided at the second plane 12a, for example. The third semiconductor laser light source 23 is provided facing the first semiconductor laser light source 21. The third semiconductor laser light source 23 includes an emission surface 23a that emits light. The emission surface 21a and the emission surface 23a are parallel to each other. The emission surface 23a is a surface of the third semiconductor laser light source 23 on an opposite side to the second substrate 12.

The third semiconductor laser light source 23 emits a third beam L3 in a third direction D3. The third direction D3 is a direction along the perpendicular line N1. The third direction D3 is a direction opposite to the first direction D1. In the illustrated example, the third direction D3 is the −Z-axis direction. The third beam L3 is condensed at a third position P3 in an optical path from the third semiconductor laser light source 23 to the third mirror 33. In the illustrated example, the third beam L3 is condensed at the third position P3 between the third semiconductor laser light source 23 and the third mirror 33. The third beam L3 condensed at the third position P3 diverges and enters the third mirror 33.

The fourth semiconductor laser light source 24 is provided at the second plane 12a of the second substrate 12. The fourth semiconductor laser light source 24 is directly provided at the second plane 12a, for example. The fourth semiconductor laser light source 24 is provided facing the second semiconductor laser light source 22. In the illustrated example, the semiconductor laser light sources 23 and 24 are arranged in the Y-axis direction. The emission surface 23a of the third semiconductor laser light source 23 and an emission surface 24a of the fourth semiconductor laser light source 24 are located at the same plane.

The fourth semiconductor laser light source 24 emits a fourth beam L4 in the third direction D3. The fourth beam L4 is condensed at a fourth position P4 in an optical path from the fourth semiconductor laser light source 24 to the fourth mirror 34. In the illustrated example, the fourth beam L4 is condensed at the fourth position P4 between the fourth semiconductor laser light source 24 and the fourth mirror 34. The fourth beam L4 condensed at the fourth position P4 diverges and enters the fourth mirror 34.

An optical path length from the third semiconductor laser light source 23 to the third position P3 is larger than an optical path length from the fourth semiconductor laser light source 24 to the fourth position P4. In the illustrated example, a distance between the third semiconductor laser light source 23 and the third position P3 is larger than a distance between the fourth semiconductor laser light source 24 and the fourth position P4. The semiconductor laser light sources 23 and 24 are, for example, PCSELs. In the semiconductor laser light sources 23 and 24, by adjusting an arrangement of photonic crystals or the like, the third position P3 and the fourth position P4 can be adjusted by composite modulation.

A radiation angle of the first beam L1 emitted from the first semiconductor laser light source 21, a radiation angle of the second beam L2 emitted from the second semiconductor laser light source 22, a radiation angle of the third beam L3 emitted from the third semiconductor laser light source 23, and a radiation angle of the fourth beam L4 emitted from the fourth semiconductor laser light source 24 are, for example, the same as each other. An optical path length from the first position P1 to the light condensing optical system 40, an optical path length from the second position P2 to the light condensing optical system 40, an optical path length from the third position P3 to the light condensing optical system 40, and an optical path length from the fourth position P4 to the light condensing optical system 40 are, for example, the same as each other.

The third mirror 33 reflects the third beam L3 emitted in the third direction D3 from the third semiconductor laser light source 23 in the second direction D2.

The fourth mirror 34 transmits the third beam L3 reflected by the third mirror 33 in the second direction D2, and reflects the fourth beam L4 emitted in the third direction D3 from the fourth semiconductor laser light source 24 in the second direction D2. Then, the fourth mirror 34 multiplexes the third beam L3 and the fourth beam L4 and guides the multiplexed beams to the light condensing optical system 40. An optical path length from the third semiconductor laser light source 23 to the fourth mirror 34 is larger than an optical path length from the fourth semiconductor laser light source 24 to the fourth mirror 34.

The fourth mirror 34 is, for example, a polarization beam combiner. For example, the semiconductor laser light sources 23 and 24, which are PCSELs, can adjust polarization directions of the beams L3 and L4 by composite modulation, respectively. The polarization directions of the beams L3 and L4 are different from each other. For example, the third beam L3 is P-polarized light, and the fourth beam L4 is S-polarized light. In the illustrated example, the mirrors 33 and 34 are arranged in the Y-axis direction. An optical path length from the third position P3 to the fourth mirror 34 and an optical path length from the fourth position P4 to the fourth mirror 34 are, for example, the same as each other.

The mirror 36 reflects the beams L1 and L2 from the second mirror 32 in the first direction D1. The mirror 37 reflects the beams L3 and L4 from the fourth mirror 34 in the third direction D3. The mirror 38 reflects the beams L3 and L4 from the mirror 37 in the second direction D2.

The fifth mirror 35 is provided in an optical path from the second mirror 32 to the light condensing optical system 40. Further, the fifth mirror 35 is provided in an optical path from the fourth mirror 34 to the light condensing optical system 40.

The fifth mirror 35 is a dichroic mirror. The first beam L1 and the second beam L2 are light having a first wavelength. The third beam L3 and the fourth beam L4 are light having a second wavelength different from the first wavelength. Therefore, the fifth mirror 35, which is a dichroic mirror, can reflect the beams L1 and L2 and transmit the beams L3 and L4. To be specific, the fifth mirror 35 reflects the beams L1 and L2 from the second mirror 32 in the second direction D2, and transmits the beams L3 and L4 from the fourth mirror 34 in the second direction D2. To be more specific, the fifth mirror 35 reflects the beams L1 and L2 reflected by the mirror 36 in the second direction D2, and transmits the beams L3 and L4 reflected by the mirror 38 in the second direction D2. The fifth mirror 35 multiplexes the beams L1 and L2 and the beams L3 and L4.

The light condensing optical system 40 condenses the first beam L1, the second beam L2, the third beam L3, and the fourth beam L4. To be specific, the light condensing optical system 40 condenses the beams L1, L2, L3, and L4 from the fifth mirror 35 at the light condensing point F.

The laser module 300 includes the second substrate 12 provided facing the first substrate 11, the third semiconductor laser light source 23 provided at the second substrate 12 and configured to emit the third beam L3 in the third direction D3 which is an opposite direction to the first direction D1, the fourth semiconductor laser light source 24 provided at the second substrate 12 and configured to emit the fourth beam L4 in the third direction D3, the third mirror 33 configured to reflect the third beam L3 emitted in the third direction D3 from the third semiconductor laser light source 23, the fourth mirror 34 configured to transmit the third beam L3 reflected by the third mirror 33 in the second direction D2 and reflect the fourth beam L4 emitted from the fourth semiconductor laser light source 24 in the second direction D2, and the fifth mirror 35 provided in the optical path from the second mirror 32 to the light condensing optical system 40 and configured to reflect the first beam L1 and the second beam L2 from the second mirror 32 in the second direction D2 and transmit the third beam L3 and the fourth beam L4 from the fourth mirror 34 in the second direction D2. The light condensing optical system 40 condenses the first beam L1, the second beam L2, the third beam L3, and the fourth beam L4 from the fifth mirror 35.

Therefore, in the laser module 300, the first beam L1, the second beam L2, the third beam L3, and the fourth beam L4 can be multiplexed. Thus, a high output can be achieved.

In the laser module 300, the first beam L1 and the second beam L2 are the light having the first wavelength, the third beam L3 and the fourth beam L4 are the light having the second wavelength different from the first wavelength, and the fifth mirror 35 is a dichroic mirror. Therefore, in the laser module 300, the first beam L1, the second beam L2, the third beam L3, and the fourth beam L4 can be multiplexed at the fifth mirror 35.

In the laser module 300, the third semiconductor laser light source 23 and the fourth semiconductor laser light source 24 are provided at the second plane 12a of the second substrate 12. Therefore, in the laser module 300, temperature characteristics of the semiconductor laser light sources 23 and 24 can be made more uniform. Therefore, temperature control for the semiconductor laser light sources 23 and 24 can be easily performed.

Note that the first beam L1 emitted from the first semiconductor laser light source 21, the second beam L2 emitted from the second semiconductor laser light source 22, the third beam L3 emitted from the third semiconductor laser light source 23, and the fourth beam L4 emitted from the fourth semiconductor laser light source 24 may be the same as each other in polarization direction. The beams L1, L2, L3, and L4 may be, for example, S-polarized light.

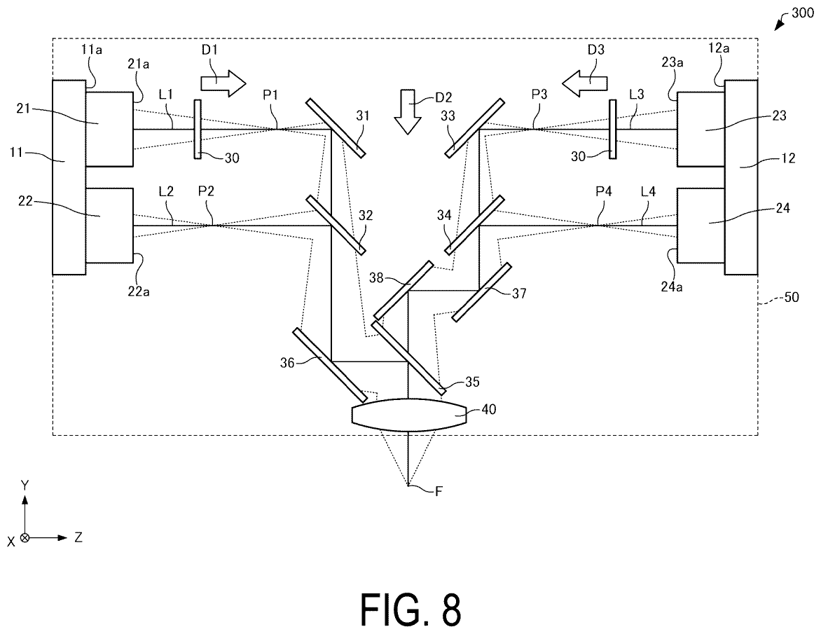

In this case, as illustrated in FIG. 8, the λ/2 plate 30 is provided in each of an optical path from the first semiconductor laser light source 21 to the first mirror 31, and the optical path from the third semiconductor laser light source 23 to the third mirror 33. The λ/2 plate 30 converts the S-polarized first beam L1 emitted from the first semiconductor laser light source 21 and the S-polarized third beam L3 emitted from the third semiconductor laser light source 23 into P-polarized light. Accordingly, the second mirror 32 can multiplex the first beam L1 emitted from the first semiconductor laser light source 21 and the second beam L2 emitted from the second semiconductor laser light source 22. Further, the fourth mirror 34 can multiplex the third beam L3 emitted from the third semiconductor laser light source 23 and the fourth beam L4 emitted from the fourth semiconductor laser light source 24.

Further, although the case where the second mirror 32 and the fourth mirror 34 are polarization beam combiners and the fifth mirror 35 is a dichroic mirror has been described above, the second mirror 32 and the fourth mirror 34 may be dichroic mirrors and the fifth mirror 35 may be a polarization beam combiner.

In this case, the first beam L1 and the third beam L3 are light having a first wavelength, and the second beam L2 and the fourth beam L4 are light having a second wavelength different from the first wavelength. The beams L1 and L2 enter the fifth mirror 35 as first polarized beams, and the beams L3 and L4 enter the fifth mirror 35 as second polarized beams different from the first polarized beam. The first polarized beam may be S-polarized light, and the second polarized beam may be P-polarized light. Although not illustrated, the semiconductor laser light sources 21 and 23 may be provided at the substrates 11 and 12 via the position adjustment mechanisms 70, respectively. The semiconductor laser light sources 21, 22, 23, and 24 may emit light having wavelengths different from each other.

However, semiconductor laser light sources that emit light having the same wavelength have the same temperature characteristics. Therefore, it is easier to control temperature when the semiconductor laser light sources 21 and 22 provided at the first substrate 11 emit light having the same wavelength and the semiconductor laser light sources 23 and 24 provided at the second substrate 12 emit light having the same wavelength. Thus, stabilization with respect to an environment can be achieved.

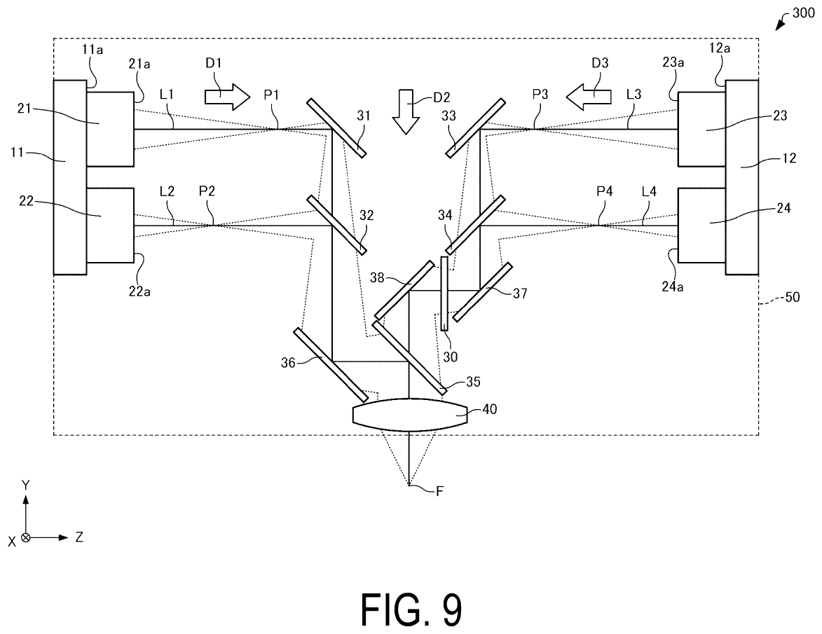

In addition, when the second mirror 32 and the fourth mirror 34 are dichroic mirrors and the fifth mirror 35 is a polarization beam combiner, the semiconductor laser light sources 21, 22, 23, and 24 may emit the first polarized beams, and the λ/2 plate 30 may be provided in an optical path from the mirror 36 to the mirror 37, as illustrated in FIG. 9. Accordingly, the beams L3 and L4 emitted from the semiconductor laser light sources 23 and 24 can be converted from the first polarized beams into the second polarized beams. By disposing the fifth mirror 35, which is a polarization beam combiner, downstream of the mirrors 32 and 34, which are dichroic mirrors, the number of polarization beam combiners can be reduced, and cost reduction can be achieved.

### 2.3. Third Modification

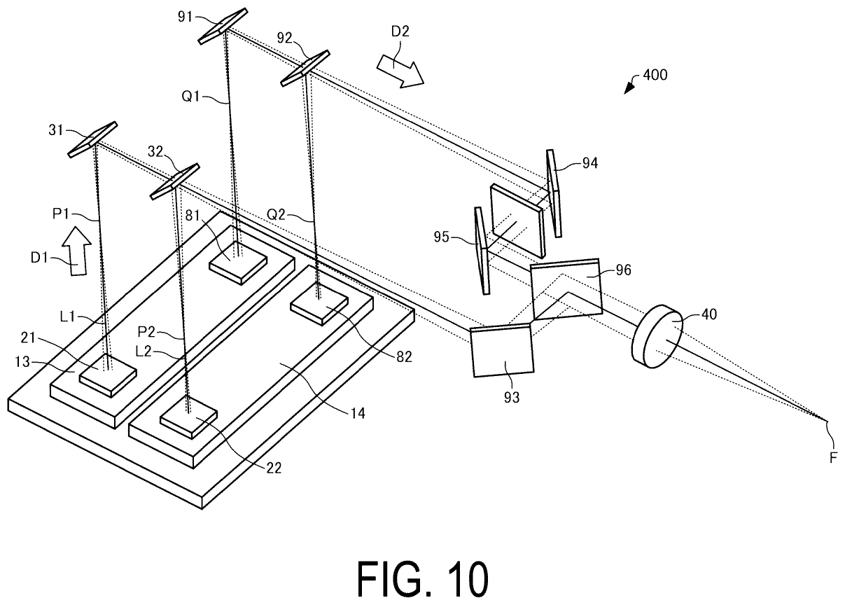

Next, a laser module according to a third modification of the embodiment will be described with reference to the drawings. FIG. 10 is a diagram schematically illustrating a laser module 400 according to the third modification of the embodiment.

In the following description, in the laser module 400 according to the third modification of the embodiment, the components with the same functions as those of the above-described laser module 100 according to the embodiment are denoted with the same reference numerals, and the description thereof is omitted.

As illustrated in FIG. 9, the laser module 400 is different from the laser module 100 described above in that substrates 13, 14, semiconductor laser light sources 81, 82, and mirrors 91, 92, 93, 94, 95, and 96 are included.

The substrates 13 and 14 are provided at the first substrate 11. A material of the substrates 13 and 14 may be the same as or different from a material of the first substrate 11. Shapes of the substrates 13 and 14 may be the same as or different from each other. Providing the substrates 13 and 14 at the first substrate 11 facilitates mounting and assembly. Further, the substrates 13 and 14 need not necessarily be provided together at the first substrate 11.

The semiconductor laser light sources 21 and 81 are provided at the substrate 13. The semiconductor laser light sources 21 and 81 are provided at the first substrate 11 via the substrate 13. The semiconductor laser light sources 22 and 82 are provided at the substrate 14. The semiconductor laser light sources 22 and 82 are provided at the first substrate 11 via the substrate 14. The semiconductor laser light sources 81 and 82 emit light in the first direction D1. An optical axis of the beam L1 emitted from the first semiconductor laser light source 21, an optical axis of the beam L2 emitted from the second semiconductor laser light source 22, an optical axis of a beam emitted from the semiconductor laser light source 81, and an optical axis of a beam emitted from the semiconductor laser light source 82 are parallel to each other.

The semiconductor laser light sources 21 and 81 emit light having wavelengths the same as each other. The semiconductor laser light sources 22 and 82 emit light having wavelengths the same as each other. In the laser module 400, the semiconductor laser light sources 21 and 81 that emit light having the same wavelength are provided at the substrate 13, and thus temperature characteristics of the semiconductor laser light sources 21 and 81 can be made the same. Further, since the semiconductor laser light sources 22 and 82 that emit light having the same wavelength are provided at the substrate 14, temperature characteristics of the semiconductor laser light sources 22 and 82 can be made the same. The semiconductor laser light sources 21 and 22 emit light having the wavelengths different from each other.

The semiconductor laser light sources 21, 22, 81, and 82 each emit light having the same polarization. The semiconductor laser light sources 21, 22, 81, and 82 emit, for example, S-polarized light.

A beam emitted from the semiconductor laser light source 81 is condensed at a position Q1 in an optical path from the semiconductor laser light source 81 to the mirror 91. An optical path length from the semiconductor laser light source 81 to the position Q1 is, for example, the same as an optical path length from the first semiconductor laser light source 21 to the first position P1. The semiconductor laser light source 81 has basically the same configuration as that of the first semiconductor laser light source 21.

A beam emitted from the semiconductor laser light source 82 is condensed at a position Q2 in an optical path from the semiconductor laser light source 82 to the mirror 92. An optical path length from the semiconductor laser light source 82 to the position Q2 is, for example, the same as an optical path length from the second semiconductor laser light source 22 to the second position P2. The semiconductor laser light source 82 has basically the same configuration as that of the second semiconductor laser light source 22.

The mirror 91 reflects light emitted in the first direction D1 from the semiconductor laser light source 81 in the second direction D2.

The mirror 92 transmits light from the mirror 91 in the second direction D2, and reflects light emitted in the first direction D1 from the semiconductor laser light source 82 in the second direction D2. The mirrors 32 and 92 are dichroic mirrors.

The mirror 93 reflects light from the second mirror 32 in a direction orthogonal to the first direction D1 and the second direction D2. The mirror 94 reflects light from the mirror 92 in a direction orthogonal to the first direction D1 and the second direction D2. The mirror 95 reflects light from the mirror 94 in the second direction D2. The λ/2 plate 30 is provided in an optical path from the mirror 94 to the mirror 95. Accordingly, the light reflected by the mirror 94 is converted from S-polarized light into P-polarized light, for example.

The mirror 96 reflects light reflected by the mirror 93 in the second direction D2, and transmits light reflected by the mirror 95 in the second direction D2. The mirror 96 is a polarization beam combiner.

The light condensing optical system 40 condenses the first beam L1 emitted from the first semiconductor laser light source 21, the second beam L2 emitted from the second semiconductor laser light source 22, a beam emitted from the semiconductor laser light source 81, and a beam emitted from the semiconductor laser light source 82. Therefore, in the laser module 400, it is possible to achieve a higher output as compared to the laser module 100, for example.

### 2.4. Fourth Modification

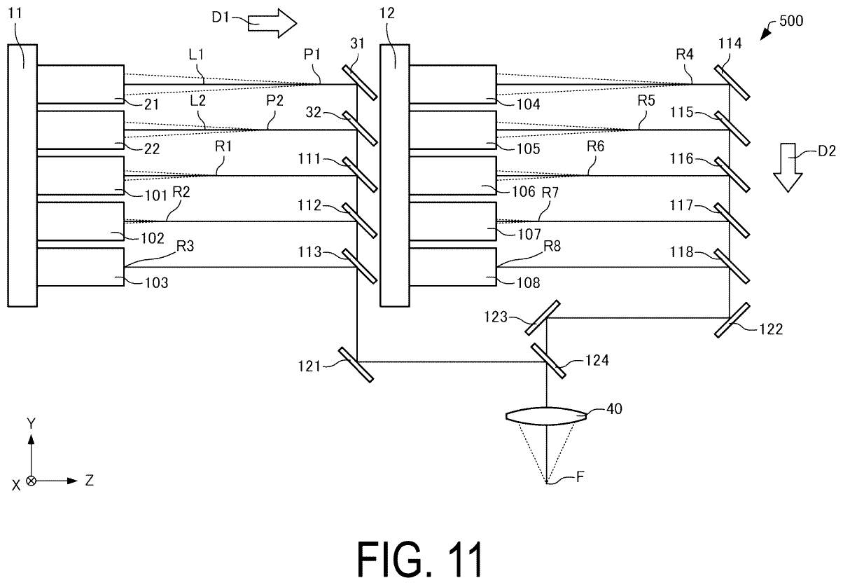

Next, a laser module according to a fourth modification of the embodiment will be described with reference to the drawings. FIG. 11 is a diagram schematically illustrating a laser module 500 according to the fourth modification of the embodiment.

In the following description, in the laser module 500 according to the fourth modification of the embodiment, the components with the same functions as those of the above-described laser module 100 according to the embodiment are denoted with the same reference numerals, and the description thereof is omitted.

As illustrated in FIG. 11, the laser module 500 is different from the laser module 100 described above in that semiconductor laser light sources 101, 102, 103, 104, 105, 106, 107, 108, mirrors 111, 112, 113, 114, 115, 116, 117, 118, 121, 122, 123, and 124 are included.

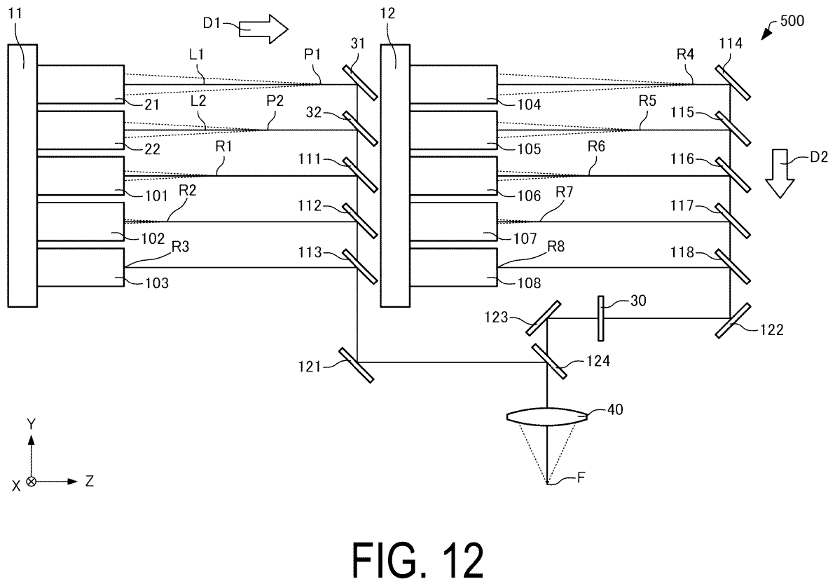

Note that for convenience, in FIG. 11, in an optical path from a semiconductor laser light source to a light condensing optical system, a part of spread of light is omitted. The same applies to FIGS. 12 to 14 described later.

The semiconductor laser light sources 101, 102, and 103 are provided at the first substrate 11. In the illustrated example, the semiconductor laser light sources 21, 22, 101, 102, and 103 are arrayed in this order in the Y-axis direction. The semiconductor laser light sources 101, 102, and 103 emit light in the first direction D1. An optical axis of the beam L1 emitted from the first semiconductor laser light source 21, an optical axis of the beam L2 emitted from the second semiconductor laser light source 22, an optical axis of a beam emitted from the semiconductor laser light source 101, an optical axis of a beam emitted from the semiconductor laser light source 102, and an optical axis of a beam emitted from the semiconductor laser light source 103 are parallel to each other.

The semiconductor laser light sources 21, 22, 101, 102, and 103 emit light having wavelengths different from each other. Although not illustrated, each of the semiconductor laser light sources 21, 22, 101, 102, and 103 may be provided at the first substrate 11 via the position adjustment mechanism 70. The semiconductor laser light sources 21, 22, 101, 102, and 103 each emit light having the same polarization. The semiconductor laser light sources 21, 22, 101, 102, and 103 emit, for example, S-polarized light.

A beam emitted from the semiconductor laser 101 is condensed at a position R1 in an optical path from the semiconductor laser light source 101 to the mirror 111. An optical path length from the semiconductor laser light source 101 to the position R1 is smaller than an optical path length from the second semiconductor laser light source 22 to the second position P2.

A beam emitted from the semiconductor laser light source 102 is condensed at a position R2 in an optical path from the semiconductor laser light source 102 to the mirror 112. An optical path length from the semiconductor laser light source 102 to the position R2 is smaller than the optical path length from the semiconductor laser light source 101 to the position R1.

A beam emitted from the semiconductor laser light source 103 is condensed at a position R3 in an optical path from the semiconductor laser light source 103 to the mirror 113. An optical path length from the semiconductor laser light source 103 to the position R3 is smaller than the optical path length from the semiconductor laser light source 102 to the position R2.

The semiconductor laser light sources 104, 105, 106, 107, and 108 are provided at the second substrate 12. In the illustrated example, the semiconductor laser light sources 104, 105, 106, 107, and 108 are arrayed in this order in the Y-axis direction. The semiconductor laser light sources 104, 105, 106, 107, and 108 emit light in the first direction D1. An optical axis of a beam emitted from the semiconductor laser light source 104, an optical axis of a beam emitted from the semiconductor laser light source 105, an optical axis of a beam emitted from the semiconductor laser light source 106, an optical axis of a beam emitted from the semiconductor laser light source 107, and an optical axis of a beam emitted from the semiconductor laser light source 108 are parallel to each other.

The semiconductor laser light sources 104, 105, 106, 107, and 108 emit light having wavelengths different from each other. Although not illustrated, each of the semiconductor laser light sources 104, 105, 106, 107, and 108 may be provided at the second substrate 12 via the position adjustment mechanism 70. The semiconductor laser light sources 104, 105, 106, 107, and 108 each emit light having the same polarization. The semiconductor laser light sources 104, 105, 106, 107, and 108 emit P-polarized light, for example. The semiconductor laser light sources 101, 102, 103, 104, 105, 106, 107, and 108 are PCSELs.

A wavelength of the first beam L1 emitted from the first semiconductor laser light source 21 and a wavelength of the beam emitted from the semiconductor laser light source 104 may be the same as each other. A wavelength of the second beam L2 emitted from the second semiconductor laser light source 22 and a wavelength of the beam emitted from the semiconductor laser light source 105 may be the same as each other. A wavelength of the beam emitted from the semiconductor laser light source 101 and a wavelength of the beam emitted from the semiconductor laser light source 106 may be the same as each other. A wavelength of the beam emitted from the semiconductor laser light source 102 and a wavelength of the beam emitted from the semiconductor laser light source 107 may be the same as each other. A wavelength of the beam emitted from the semiconductor laser light source 103 and a wavelength of the beam emitted from the semiconductor laser light source 108 may be the same as each other.

The beam emitted from the semiconductor laser light source 104 is condensed at a position R4 in an optical path from the semiconductor laser light source 104 to the mirror 114. An optical path length from the semiconductor laser light source 104 to the position R4 is, for example, the same as an optical path length from the first semiconductor laser light source 21 to the first position P1.

The beam emitted from the semiconductor laser light source 105 is condensed at a position R5 in an optical path from the semiconductor laser light source 105 to the mirror 115. An optical path length from the semiconductor laser light source 105 to the position R5 is, for example, the same as the optical path length from the second semiconductor laser light source 22 to the second position P2.

The beam emitted from the semiconductor laser light source 106 is condensed at a position R6 in an optical path from the semiconductor laser light source 106 to the mirror 116. An optical path length from the semiconductor laser light source 106 to the position R6 is, for example, the same as the optical path length from the semiconductor laser light source 101 to the position R1.

The beam emitted from the semiconductor laser light source 107 is condensed at a position R7 in an optical path from the semiconductor laser light source 107 to the mirror 117. An optical path length from the semiconductor laser light source 107 to the position R7 is, for example, the same as the optical path length from the semiconductor laser light source 102 to the position R2.

The beam emitted from the semiconductor laser light source 108 is condensed at a position R8 in an optical path from the semiconductor laser light source 108 to the mirror 118. An optical path length from the semiconductor laser light source 108 to the position R8 is, for example, the same as the optical path length from the semiconductor laser light source 107 to the position R7.

The mirror 111 transmits the beams L1 and L2 from the second mirror 32 in the second direction D2, and reflects light emitted in the first direction D1 from the semiconductor laser light source 101 in the second direction D2.

The mirror 112 transmits light from the mirror 111 in the second direction D2, and reflects light emitted in the first direction D1 from the semiconductor laser light source 102 in the second direction D2.

The mirror 113 transmits light from the mirror 112 in the second direction D2, and reflects light emitted in the first direction D1 from the semiconductor laser light source 103 in the second direction D2. The mirrors 32, 111, 112, and 113 are dichroic mirrors.

The mirror 114 reflects light emitted in the first direction D1 from the semiconductor laser light source 104 in the second direction D2.

The mirror 115 transmits light reflected by the mirror 114 in the second direction D2, and reflects light emitted in the first direction D1 from the semiconductor laser light source 105 in the second direction D2.

The mirror 116 transmits light from the mirror 115 in the second direction D2, and reflects light emitted in the first direction D1 from the semiconductor laser light source 106 in the second direction D2.

The mirror 117 transmits light from the mirror 116 in the second direction D2, and reflects light emitted in the first direction D1 from the semiconductor laser light source 107 in the second direction D2.

The mirror 118 transmits light from the mirror 117 in the second direction D2, and reflects light emitted in the first direction D1 from the semiconductor laser light source 108 in the second direction D2. The mirrors 114, 115, 116, 117, and 118 are dichroic mirrors.

The mirror 121 reflects light from the mirror 113 in the first direction D1. The mirror 122 reflects light from the mirror 118 in an opposite direction to the first direction D1. The mirror 123 reflects light from the mirror 122 in the second direction D2.

The mirror 124 reflects light from the mirror 121 in the second direction D2 and transmits light from the mirror 123 in the second direction D2. The mirror 124 is a polarization beam combiner.

The light condensing optical system 40 condenses beams emitted from the semiconductor laser light source 21, 22, 101, 102, 103, 104, 105, 106, 107, and 108. Therefore, in the laser module 500, it is possible to achieve a higher output as compared to the laser module 100.

Note that the semiconductor laser light sources 104, 105, 106, 107, and 108 may emit light having the same polarization as that of the semiconductor laser light sources 21, 22, 101, 102, and 103, for example. In this case, as illustrated in FIG. 12, the λ/2 plate 30 is provided in an optical path from the mirror 122 to the mirror 123.

Accordingly, light emitted from the semiconductor laser light sources 104, 105, 106, 107, and 108 can be converted from S-polarized light into P-polarized light, for example.

Further, the number of semiconductor laser light sources and the number of mirrors are not particularly limited.

### 2.5. Fifth Modification

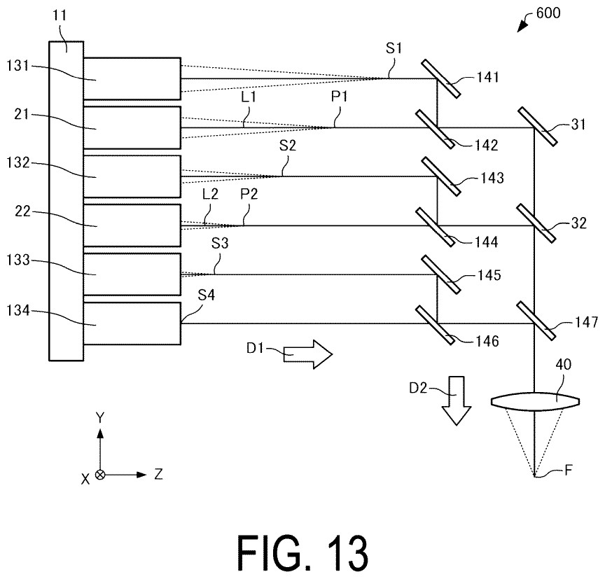

Next, a laser module according to a fifth modification of the embodiment will be described with reference to the drawings. FIG. 13 is a diagram schematically illustrating a laser module 600 according to the fifth modification of the embodiment.

In the following description, in the laser module 600 according to the fifth modification of the embodiment, the components with the same functions as those of the above-described laser module 100 according to the embodiment are denoted with the same reference numerals, and the description thereof is omitted.

As illustrated in FIG. 13, the laser module 600 is different from the laser module 100 described above in that semiconductor laser light sources 131, 132, 133, 134, mirrors 141, 142, 143, 144, 145, 146, and 147 are included.

The semiconductor laser light sources 131, 132, 133, and 134 are provided at the first substrate 11. In the illustrated example, the semiconductor laser light sources 131, 21, 132, 22, 133, and 134 are arrayed in this order in the Y-axis direction. The semiconductor laser light sources 131, 132, 133, and 134 emit light in the first direction D1. An optical axis of the beam L1 emitted from the first semiconductor laser light source 21, an optical axis of the beam L2 emitted from the second semiconductor laser light source 22, an optical axis of a beam emitted from the semiconductor laser light source 131, an optical axis of a beam emitted from the semiconductor laser light source 132, an optical axis of a beam emitted from the semiconductor laser light source 133, and an optical axis of a beam emitted from the semiconductor laser light source 134 are parallel to each other.

The semiconductor laser light sources 21 and 131 emit light having wavelengths the same as each other. The semiconductor laser light sources 22 and 132 emit light having wavelengths the same as each other. The semiconductor laser light sources 133 and 134 emit light having wavelengths the same as each other. The semiconductor laser light sources 21, 22, and 133 emit light having the wavelengths different from each other. Although not illustrated, each of the semiconductor laser light sources 21, 22, 131, 132, 133, and 134 may be provided at the first substrate 11 via the position adjustment mechanism 70.

The semiconductor laser light source 21, 22, and 134 emit first polarized beams. The semiconductor laser light source 21, 22, and 134 emit, for example, P-polarized light. The semiconductor laser light sources 131, 132, and 133 emit second polarized beams different from the first polarized beams. The semiconductor laser light sources 131, 132, and 133 emit, for example, S-polarized light. The semiconductor laser light sources 131, 132, 133, and 134 are, for example, PCSELs.

The beam emitted from the semiconductor laser 131 is condensed at a position S1 in an optical path from the semiconductor laser light source 131 to the mirror 141. An optical path length from the semiconductor laser light source 131 to the position S1 is larger than an optical path length from the first semiconductor laser light source 21 to the first position P1.

The beam emitted from the semiconductor laser 132 is condensed at a position S2 in an optical path from the semiconductor laser light source 132 to the mirror 142. An optical path length from the semiconductor laser light source 132 to the position S2 is smaller than the optical path length from the first semiconductor laser light source 21 to the first position P1, and is larger than an optical path length from the second semiconductor laser light source 22 to the second position P2.

The beam emitted from the semiconductor laser 133 is condensed at a position S3 in an optical path from the semiconductor laser light source 133 to the mirror 143. An optical path length from the semiconductor laser light source 133 to the position S3 is smaller than the optical path length from the second semiconductor laser light source 22 to the second position P2.

The beam emitted from the semiconductor laser 134 is condensed at a position S4 in an optical path from the semiconductor laser light source 134 to the mirror 144. An optical path length from the semiconductor laser light source 134 to the position S4 is smaller than the optical path length from the semiconductor laser light source 133 to the position S3.

The mirror 141 reflects light emitted in the first direction D1 from the semiconductor laser light source 131 in the second direction D2.

The mirror 142 transmits light emitted in the first direction D1 from the first semiconductor laser light source 21 in the first direction D1, and reflects light reflected by the mirror 141 in the first direction D1. The mirror 142 is a polarization beam combiner.

The mirror 143 reflects light emitted in the first direction D1 from the semiconductor laser light source 132 in the second direction D2.

The mirror 144 transmits light emitted in the first direction D1 from the second semiconductor laser light source 22 in the first direction D1, and reflects light reflected by the mirror 143 in the first direction D1. The mirror 144 is a polarization beam combiner.

The mirror 145 reflects light emitted in the first direction D1 from the semiconductor laser light source 133 in the second direction D2.

The mirror 146 transmits light emitted in the first direction D1 from the semiconductor laser light source 134 in the first direction D1, and reflects light reflected by the mirror 145 in the first direction D1. The mirror 146 is a polarization beam combiner.

The first mirror 31 reflects light from the mirror 142 in the second direction D2.

The second mirror 32 transmits light from the first mirror 31 in the second direction D2 and reflects light from the mirror 144 in the second direction D2. The second mirror 32 is a dichroic mirror.

The mirror 147 transmits light from the second mirror 32 in the second direction D2 and reflects light from the mirror 146 in the second direction D2. The mirror 147 is a dichroic mirror.

The light condensing optical system 40 condenses beams emitted from the semiconductor laser light sources 21, 22, 131, 132, 133, and 134. Therefore, in the laser module 600, it is possible to achieve a higher output as compared to, for example, the laser module 100.

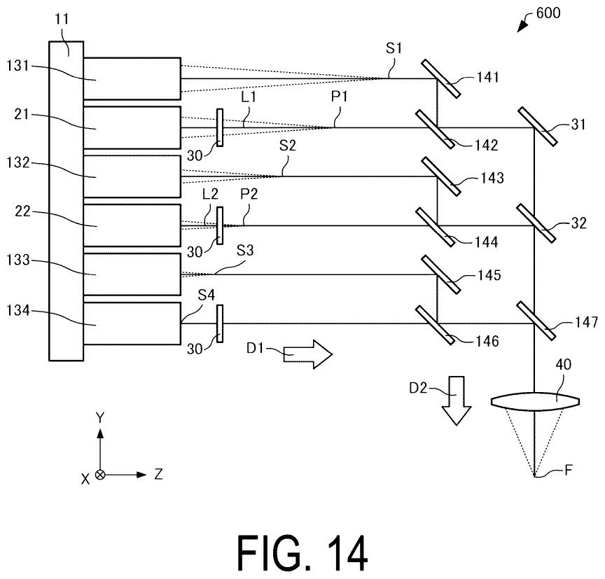

Note that the semiconductor laser light sources 21, 22, 131, 132, 133, and 134 may each emit light having the same polarization. In this case, as illustrated in FIG. 14, the λ/2 plate 30 is provided in each of an optical path from the first semiconductor laser light source 21 to the mirror 142, an optical path from the second semiconductor laser light source 22 to the mirror 144, and an optical path from the semiconductor laser light source 134 to the mirror 146. Accordingly, light emitted from the semiconductor laser light sources 21, 22, and 134 can be converted from S-polarized light into P-polarized light, for example.

Further, the number of semiconductor laser light sources and the number of mirrors are not particularly limited.

### 3. Laser Processing Machine

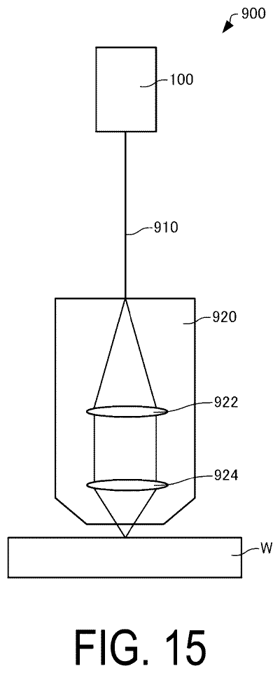

Next, a laser processing machine according to the embodiment will be described with reference to the drawings. FIG. 15 is a diagram schematically illustrating a laser processing machine 900 according to the embodiment.

As illustrated in FIG. 15, the laser processing machine 900 includes, for example, the laser module 100, an optical fiber 910, and a processing head 920.

Light emitted from the laser module 100 is guided to the processing head 920 through the optical fiber 910.

The laser processing machine 900 processes a workpiece W. Specifically, in the laser processing machine 900, the processing head 920 is moved relative to the workpiece W, and light is radiated from the processing head 920 to process the workpiece W. The processing head 920 includes lenses 922 and 924. The lenses 922 and 924 condense light radiated from the optical fiber 910 and guides the light to the workpiece W. A material of the workpiece W is not particularly limited, and may be metal, resin, or a ceramic. Additionally, although not illustrated, the laser processing machine 900 need not include the optical fiber 910, and the laser module 100 may be incorporated in the processing head 920.

Note that uses of the laser processing machine according to the present disclosure are not particularly limited. The laser processing machine according to the present disclosure may be a processing machine for cutting the workpiece W or drilling a hole in the workpiece W. Further, the laser processing machine according to the present disclosure may be, for example, a laser cleaner that removes rust or the like attached to metal by laser light, a laser annealing device that heats a surface of metal or resin with laser light, or a 3D printer.

Further, the laser processing machine according to the present disclosure may include a laser module other than the laser module 100 as long as the laser module is a laser module according to the present disclosure.

The embodiment and the modifications described above are merely examples, and are not intended as limiting. For example, each embodiment and each modification can also be combined together as appropriate.

The present disclosure includes configurations that are substantially identical to the configurations described in the embodiment, for example, configurations with identical functions, methods and results, or with identical advantages and effects. Also, the present disclosure includes configurations obtained by replacing non-essential portions of the configurations described in the embodiment. In addition, the present disclosure also includes configurations that achieve the same effects as the configurations described in the embodiments or configurations that can achieve the same advantages. Further, the present disclosure includes configurations obtained by adding known techniques to the configurations described in the embodiment.

The following contents are derived from the embodiment and the modification examples described above.

An aspect of a laser module includes
a first substrate,
a first semiconductor laser light source provided at the first substrate and configured to emit a first beam in a first direction,
a second semiconductor laser light source provided at the first substrate and configured to emit a second beam in the first direction,
a first mirror configured to reflect the first beam emitted in the first direction from the first semiconductor laser light source,
a second mirror configured to transmit the first beam reflected by the first mirror in a second direction different from the first direction and reflect the second beam emitted from the second semiconductor laser light source in the second direction, and
a light condensing optical system configured to condense the first beam and the second beam from the second mirror, wherein
the first beam emitted from the first semiconductor laser light source is condensed at a first position in an optical path from the first semiconductor laser light source to the first mirror,
the second beam emitted from the second semiconductor laser light source is condensed at a second position in an optical path from the second semiconductor laser light source to the second mirror,
an optical path length from the first semiconductor laser light source to the first position is larger than an optical path length from the second semiconductor laser light source to the second position, and
an optical path length from the first semiconductor laser light source to the light condensing optical system is larger than an optical path length from the second semiconductor laser light source to the light condensing optical system.

According to this laser module, positions of the first semiconductor laser light source and the second semiconductor laser light source can be easily adjusted.

In an aspect of the laser module,
the first beam and the second beam may enter the second mirror as beams different from each other in polarization direction, and
the second mirror may be a polarization beam combiner.

According to this laser module, the first beam and the second beam can be multiplexed at the second mirror.

In an aspect of the laser module,
the first beam and the second beam may be different from each other in wavelength, and
the second mirror may be a dichroic mirror.

According to this laser module, the first beam and the second beam can be multiplexed at the second mirror.

In an aspect of the laser module,
the first semiconductor laser light source and the second semiconductor laser light source may be provided at a first plane of the first substrate.

According to this laser module, temperature characteristics of the first semiconductor laser light source and temperature characteristics of the second semiconductor laser light source can be made more uniform.

In an aspect of the laser module,
a second substrate provided facing the first substrate,
a third semiconductor laser light source provided at the second substrate and configured to emit a third beam in a third direction that is an opposite direction to the first direction,
a fourth semiconductor laser light source provided at the second substrate and configured to emit a fourth beam in the third direction,
a third mirror configured to reflect the third beam emitted in the third direction from the third semiconductor laser light source,
a fourth mirror configured to transmit the third beam reflected by the third mirror in the second direction and reflect the fourth beam emitted from the fourth semiconductor laser light source in the second direction, and
a fifth mirror provided in an optical path from the second mirror to the light condensing optical system, and configured to reflect the first beam and the second beam from the second mirror in the second direction, and transmit the third beam and the fourth beam from the fourth mirror in the second direction
may be included, wherein
the light condensing optical system may condense the first beam, the second beam, the third beam, and the fourth beam from the fifth mirror.

According to this laser module, it is possible to achieve a high output.

In an aspect of the laser module,
the first beam and the second beam may enter the fifth mirror as first polarized beams,
the third beam and the fourth beam may enter the fifth mirror as second polarized beams different from the first polarized beams, and
the fifth mirror may be a polarization beam combiner.

According to this laser module, the first beam, the second beam, the third beam, and the fourth beam can be multiplexed.

In an aspect of the laser module,
the first beam and the second beam may be light having a first wavelength,
the third beam and the fourth beam may be light having a second wavelength different from the first wavelength, and
the fifth mirror may be a dichroic mirror.

According to this laser module, the first beam, the second beam, the third beam, and the fourth beam can be multiplexed.

In an aspect of the laser module,
the third semiconductor laser light source and the fourth semiconductor laser light source may be provided at a second plane of the second substrate.

According to this laser module, temperature characteristics of the third semiconductor laser light source and temperature characteristics of the fourth semiconductor laser light source can be made more uniform.

In an aspect of the laser module,
the first semiconductor laser light source and the second semiconductor laser light source may have different emission surface positions in the first direction.

According to this laser module, color aberration of the light condensing optical system can be corrected.

In an aspect of the laser module,
the first semiconductor laser light source and the second semiconductor laser light source may be photonic crystal surface emitting lasers.

According to this laser module, the first position and the second position can be adjusted.

An aspect of a laser processing machine includes a laser module.

What is claimed is:

1. A laser module, comprising:
a first substrate;
a first semiconductor laser light source provided at the first substrate and configured to emit a first beam in a first direction;
a second semiconductor laser light source provided at the first substrate and configured to emit a second beam in the first direction;
a first mirror configured to reflect the first beam emitted in the first direction from the first semiconductor laser light source;
a second mirror configured to transmit the first beam reflected by the first mirror in a second direction different from the first direction and reflect the second beam emitted from the second semiconductor laser light source in the second direction; and
a light condensing optical system configured to condense the first beam and the second beam from the second mirror, wherein
the first beam emitted from the first semiconductor laser light source is condensed at a first position in an optical path from the first semiconductor laser light source to the first mirror,
the second beam emitted from the second semiconductor laser light source is condensed at a second position in an optical path from the second semiconductor laser light source to the second mirror,
an optical path length from the first semiconductor laser light source to the first position is larger than an optical path length from the second semiconductor laser light source to the second position, and
an optical path length from the first semiconductor laser light source to the light condensing optical system is larger than an optical path length from the second semiconductor laser light source to the light condensing optical system.

2. The laser module according to claim 1, wherein
the first beam and the second beam enter the second mirror as beams different from each other in polarization direction, and
the second mirror is a polarization beam combiner.

3. The laser module according to claim 1, wherein
the first beam and the second beam are different from each other in wavelength, and
the second mirror is a dichroic mirror.

4. The laser module according to claim 1, wherein
the first semiconductor laser light source and the second semiconductor laser light source are provided at a first plane of the first substrate.

5. The laser module according to claim 1, comprising:
a second substrate provided facing the first substrate;
a third semiconductor laser light source provided at the second substrate and configured to emit a third beam in a third direction being an opposite direction to the first direction;
a fourth semiconductor laser light source provided at the second substrate and configured to emit a fourth beam in the third direction;
a third mirror configured to reflect the third beam emitted in the third direction from the third semiconductor laser light source;
a fourth mirror configured to transmit the third beam reflected by the third mirror in the second direction and reflect the fourth beam emitted from the fourth semiconductor laser light source in the second direction; and
a fifth mirror provided in an optical path from the second mirror to the light condensing optical system, and configured to reflect the first beam and the second beam from the second mirror in the second direction, and transmit the third beam and the fourth beam from the fourth mirror in the second direction, wherein
the light condensing optical system condenses the first beam, the second beam, the third beam, and the fourth beam from the fifth mirror.

6. The laser module according to claim 5, wherein
the first beam and the second beam enter the fifth mirror as first polarized beams,
the third beam and the fourth beam enter the fifth mirror as second polarized beams different from the first polarized beams, and
the fifth mirror is a polarization beam combiner.

7. The laser module according to claim 5, wherein
the first beam and the second beam are light having a first wavelength,
the third beam and the fourth beam are light having a second wavelength different from the first wavelength, and
the fifth mirror is a dichroic mirror.

8. The laser module according to claim 5, wherein
the third semiconductor laser light source and the fourth semiconductor laser light source are provided at a second plane of the second substrate.

9. The laser module according to claim 3, wherein
the first semiconductor laser light source and the second semiconductor laser light source have different emission surface positions in the first direction.

10. The laser module according to claim 1, wherein
the first semiconductor laser light source and the second semiconductor laser light source are photonic crystal surface emitting lasers.

11. A laser processing machine comprising the laser module according to claim 1.
